(19) United States
(12) Patent Application Publication
(10) Pub. No.: US 2013/0318251 A1
(43) Pub. Date: Nov. 28, 2013

(54) ADAPTIVE MULTIPATH CONTENT STREAMING

(71) Applicants: Alimuddin Mohammad, Redmond, WA (US); Yi Jing, Bellevue, WA (US); Robert J. Rencher, Normandy Park, WA (US)

(72) Inventors: Alimuddin Mohammad, Redmond, WA (US); Yi Jing, Bellevue, WA (US); Robert J. Rencher, Normandy Park, WA (US)

(21) Appl. No.: 13/477,959

(22) Filed: May 22, 2012

(51) Int. Cl. G06F 15/16

(52) U.S. Cl. 709/231

(57) ABSTRACT

Systems and methods for adaptive multipath content streaming in communication networks are disclosed. In one embodiment, a computer-based system to manage content streaming from a sender to a receiver comprises a processor and logic instructions stored in a tangible computer-readable medium coupled to the processor which, when executed by the processor, configure the processor to split an encoded content stream into a plurality of parallel content streams including a first content stream comprising a base layer and at least a first additional layer, wherein the base layer contains a low-bandwidth content stream and reference information for additional layers and a second content stream comprising the base layer and at least a second additional layer, and a transmitter to transmit at least one of the first content stream or the second content stream from the sender to the receiver based at least in part on an available bandwidth parameter.

### BACKGROUND

The subject matter described herein relates to communication networks, and more particularly to adaptive multipath content streaming in communication networks. Video capture and processing systems with multiple interfaces may have multiple paths for transmission viz., the public internet, overlay networks, and/or private wired/wireless networks; and may transmit content including data, audio, images, and video streams over one or more of these available communication networks. The amount of bandwidth available for data transmission may vary widely as a function of the location of the video capturing and distribution system. Accordingly, systems and methods to manage content distribution in a variable environment may find utility.

### SUMMARY

Systems and methods for adaptive multipath content streaming in communication networks are disclosed. In one embodiment, a computer-based method to manage content streaming from a sender to a receiver comprises splitting an encoded content stream into a plurality of parallel content streams including a first content stream comprising a base layer and at least a first additional layer, wherein the base layer contains a low-bandwidth content stream and reference information for additional layers, and a second content stream comprising the base layer and at least a second additional layer, and transmitting at least one of the first content stream or the second content stream from the sender to the receiver based at least in part on an available bandwidth parameter.

In another embodiment, a computer-based system to manage content streaming from a sender to a receiver comprises a processor and logic instructions stored in a tangible computer-readable medium coupled to the processor which, when executed by the processor, configure the processor to split an encoded content stream into a plurality of parallel content streams including a first content stream comprising a base layer and at least a first additional layer, wherein the base layer contains a low-bandwidth content stream and reference information for additional layers and a second content stream comprising the base layer and at least a second additional layer, and a transmitter to transmit at least one of the first content stream or the second content stream from the sender to the receiver based at least in part on an available bandwidth parameter.

In another embodiment, a computer program product comprising logic instructions stored in a tangible computer-readable medium coupled to a processor which, when executed by the processor, configure the processor to split an encoded content stream into a plurality of parallel content streams including a first content stream comprising a base layer and at least a first additional layer, wherein the base layer contains a low-bandwidth content stream and reference information for additional layers and a second content stream comprising the base layer and at least a second additional layer, and forward the first content stream and second content stream to a transmitter to transmit at least one of the first content stream or the second content stream from a sender to a receiver based at least in part on an available bandwidth parameter.

Further areas of applicability will become apparent from the description provided herein. It should be understood that the description and specific examples are intended for purposes of illustration only and are not intended to limit the scope of the present disclosure

### BRIEF DESCRIPTION OF THE DRAWINGS

Embodiments of methods, systems, and computer program products in accordance with the teachings of the present disclosure are described in detail below with reference to the following drawings.

FIG. 1 is a schematic illustration of a communication network in which adaptive multipath content streaming may be implemented, according to embodiments.

FIG. 2 is a schematic illustration of a computing device which may be adapted to implement a system and method for adaptive multipath content streaming in accordance with some embodiments.

FIG. 3 is a flowchart illustrating operations in a method for adaptive multipath content streaming according to embodiments.

### DETAILED DESCRIPTION

Systems and methods for adaptive multipath content streaming are described herein. Specific details of certain embodiments are set forth in the following description and figures to provide a thorough understanding of such embodiments. One skilled in the art will understand, however, that alternate embodiments may be practiced without several of the details described in the following description.

Various embodiments described here are set in the context of streaming content from a content server to a receiver. In some embodiments the content server may be one component of a video capture and processing system which streams content from anywhere (for e.g. airport terminals, maintenance hangars) using mobile devices including fixed devices on mobile platforms. The streamed content may include text, pictures, audio and/or video. In accordance with embodiments described herein, a content streams may be divided into multiple different content streams, each of which includes a base layer and may include one or more additional layers of content. In some embodiments a determination is made regarding whether a multiple communication channels are available between the sender and the receiver and an approximation of available bandwidth on each communication channel is determined. The one or more content streams may be assigned to a communication channel which has a bandwidth available that most closely matches the bandwidth requirement of the content stream. This allows for efficient bandwidth allocation across the communication medium and builds redundancy into the system. In the event that multiple content streams are transmitted across multiple communication channels, the multiple content streams are combined in the receiver to form a combined content stream, which may be presented on a display.

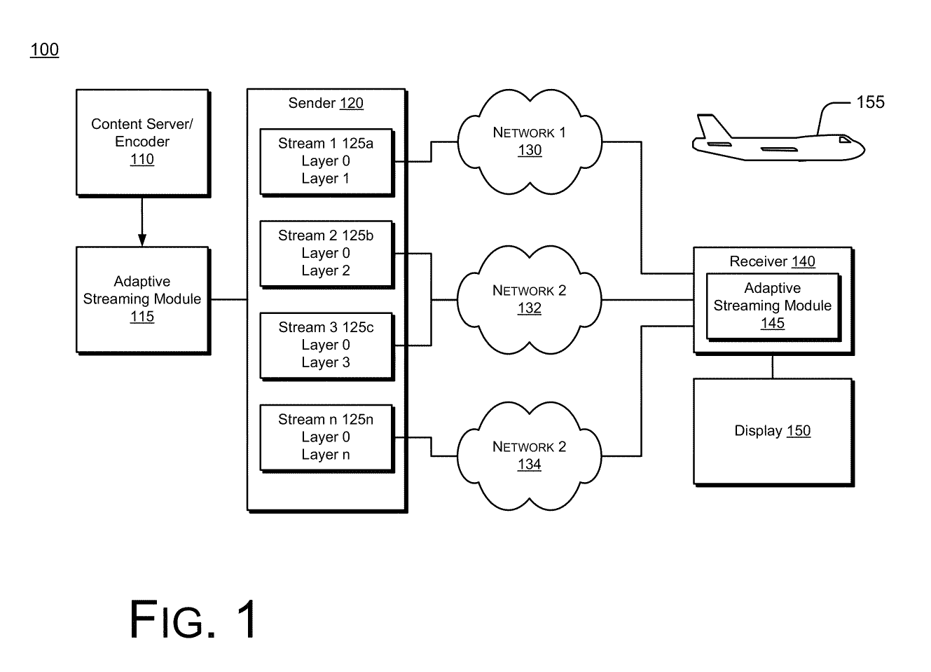

FIG. 1 is a schematic illustration of a system 100 for adaptive multipath content streaming according to embodiments. Referring to FIG. 1, in brief overview in one embodiment a content server and encoder 110. The content server and encoder 110 may be embodied as a computer system configured to encode video streams associated with digital content files. The encoder portion may encode the video streams in accordance with one or more protocols, which may be proprietary protocol or standards-based protocols. In accordance with embodiments, and adaptive streaming module 115 may be interposed between the content server/encoder 110 and a sender 120.

The adaptive streaming module 115 may implement operations which splits an encoded content stream into multiple content streams, which may be transmitted by the sender 120 over multiple networks 130, 132, 134. Communication networks 130, 132, 134 may be embodied as a as a Personal Area Network (PAN), Local Area Network (LAN), Metropolitan Area Network (MAN) or a Wide Area Network (WAN), a proprietary communication network, or the like. Furthermore, communication networks 130, 132, 134 may comprise one or more sub-networks. By way of example, and not by limitation, communication networks 130, 132, 134 may comprise one or more access points (APs) that establish access to a LAN or directly to a backbone network such as the Internet. Additionally, the communication networks 130, 132, 134 may include a variety of input/output transports such as, but not limited to; wired USB or serial links, Wireless 802.11x link, wireless USB, Blue-tooth, infra red links, cellular networks, or the like.

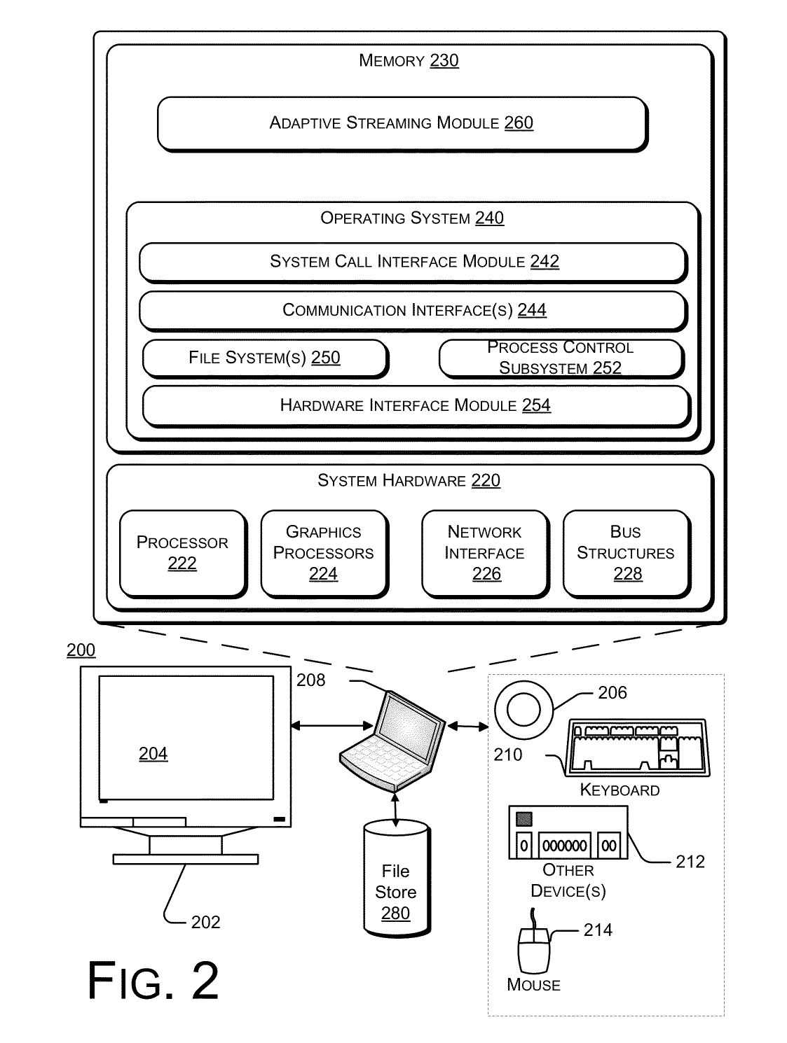

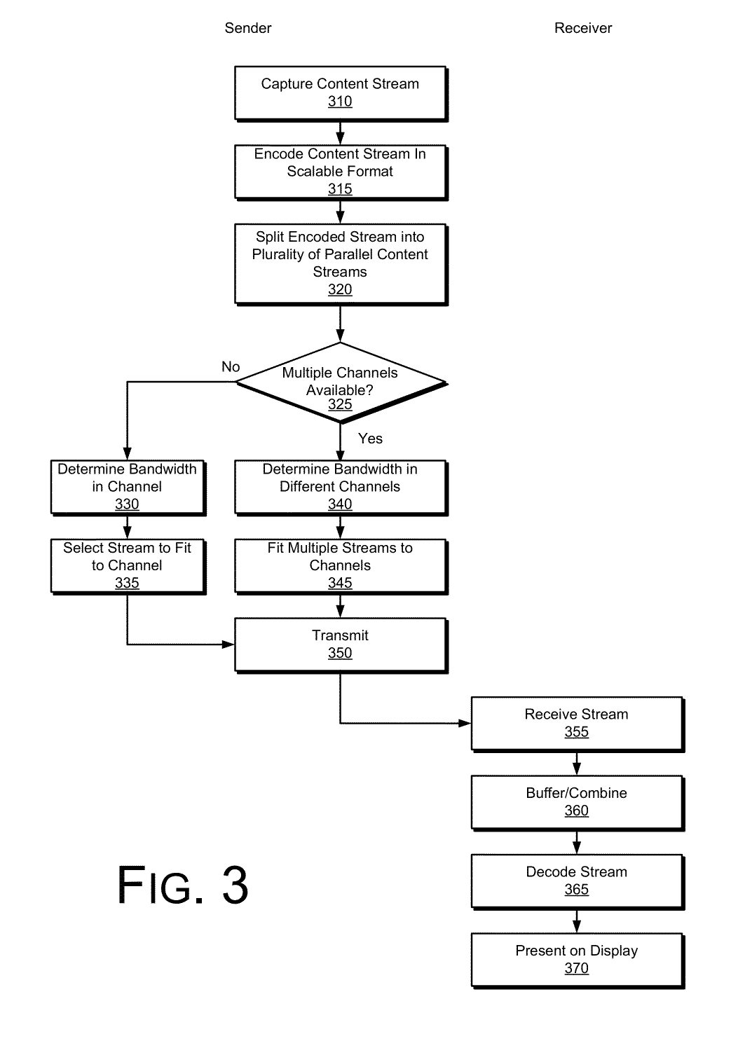

A receiver 140 includes a buffer/combiner 145, which combines the separate content streams into a combined content stream, which may be presented on a display 150. In some embodiments the receiver 140 and display 150 may be components of a vehicle, such as aircraft 155. Structural features and operations of the various components of the system 100 will be explained in greater detail with reference to FIGS. 2-3.

In some embodiments both the various components of the system 100 depicted in FIG. 1 may be implemented in a computer system environment. FIG. 2 is a schematic illustration of a computing system 200 which may be adapted to implement an content server/encoder 110 and adaptive streaming module 115 and the receiver 140 and display 150 in accordance with some embodiments. In one embodiment, system 200 includes a computing device 208 and one or more accompanying input/output devices including a display 202 having a screen 204, one or more speakers 206, a keyboard 210, one or more other I/O device(s) 212, and a mouse 214. The other I/O device(s) 212 may include a touch screen, a voice-activated input device, a track ball, and any other device that allows the system 200 to receive input from a user.

The computing device 208 includes system hardware 220 and memory 230, which may be implemented as random access memory and/or read-only memory. A file store 280 may be communicatively coupled to computing device 208. File store 280 may be internal to computing device 108 such as, e.g., one or more hard drives, CD-ROM drives, DVD-ROM drives, or other types of storage devices. File store 280 may also be external to computer 208 such as, e.g., one or more external hard drives, network attached storage, or a separate storage network.

System hardware 220 may include one or more processors 222, one or more graphics processors 224, network interfaces 226, and bus structures 228. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 224 may function as adjunct processors that manages graphics and/or video operations. Graphics processor(s) 224 may be integrated onto the motherboard of computing system 200 or may be coupled via an expansion slot on the motherboard.

In one embodiment, network interface 226 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 228 connect various components of system hardware 228. In one embodiment, bus structures 228 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 230 may include an operating system 240 for managing operations of computing device 208. In one embodiment, operating system 240 includes a hardware interface module 254 that provides an interface to system hardware 220. In addition, operating system 240 may include a file system 250 that manages files used in the operation of computing device 208 and a process control subsystem 252 that manages processes executing on computing device 208.

Operating system 240 may include (or manage) one or more communication interfaces that may operate in conjunction with system hardware 220 to transceive data packets and/or data streams from a remote source. Operating system 240 may further include a system call interface module 242 that provides an interface between the operating system 240 and one or more application modules resident in memory 130. Operating system 240 may be embodied as a Windows® brand operating system or as a UNIX operating system or any derivative thereof (e.g., Linux, Solaris, etc.), or other operating systems.

In one embodiment, memory 230 includes an adaptive streaming module 260, which may include logic instructions encoded in a tangible computer-readable medium which, when executed by processor 222, cause the processor 222 to implement adaptive streaming operations. Referring back to FIG. 1, in some embodiments the adaptive streaming module 260 may correspond to the adaptive streaming module 115 on the sending side of the network and to the adaptive streaming module 145 on the receiving side of the network.

FIG. 3 is a flowchart illustrating operations in a method for adaptive content streaming according to embodiments. In some embodiments the operations on the sending side of the network may be implemented by the adaptive streaming module 115, alone or in cooperation with other components of the sender, while operations on the receiving side of the network may be implemented by the adaptive streaming module 145 in the receiver. In order to measure bandwidth between sender and receiver, the adaptive streaming module should be co-located with the sender (i.e., on same LAN segment of network; or being connected by a local high speed intranet)

Referring to FIG. 3, at operation 310 a content stream is captured and at operation 315 the content stream is encoded in a scalable format. In some embodiments the content server/encoder 110 may be configured to encode video streams in accordance with audio and video compression and transmission standards such as the Moving Picture Experts Group (MPEG) family of standards. Streamed video may be encoded and transmitted in Network Abstraction Layer Units (NAL units or NALUs). In some embodiments the content server/encoder 110 may implement a scalable encoding scheme pursuant to which video is encoded into a base layer (layer 0) which is compatible with non-scalable video encoding schemes such as the H.264 MPEG scheme and one or more additional layers (layer 1, layer 2 . . . layer n). The base layer (layer 0) includes all information required to transmit and decode a video stream including a Sequence Parameter Set (SPS) NAL unit which contains information such as the aspect ratio, video format, timing information, etc., and a Picture Parameter Set (PPS) NAL unit which contains information such as coding for compression, etc. Each additional layers (layer 1, layer 2, . . . layer n) may include a subset sequence parameter set (SUBSPS) NAL unit which identifies characteristics of the respective additional layer.

At operation 320 the encoded content stream is split into a plurality of parallel content streams. Referring briefly to FIG. 1, in some embodiments the adaptive streaming module 115 may be interposed between the content server/encoder 110 and a sender 120. The adaptive streaming module 115 may implement operations which define a plurality of parallel content streams. Each content stream includes a base layer (layer 0) and one or more additional layers. Thus, in the embodiment depicted in FIG. 1 the adaptive streaming module generates content stream 1 125a which includes the base layer (layer 0) and additional layer 1, stream 2 125b which includes the base layer (layer 0) and additional layer 2, stream 3 125c which includes the base layer (layer 0) and additional layer 3, up to layer n which includes the base layer (layer 0) and additional layer n.

At operation 325 it is determined whether there are multiple communication channels available between the sender and the receiver. In some embodiments there may be multiple communication channels between the sender and the receiver via the multiple networks 130, 132, 134. By way of example, in some embodiments the adaptive streaming module 115 may track the available communication channels between the sender 120 and receiver 140.

If, at operation 325, there is only a single communication channel available then control passes to operation 330 and the available bandwidth in the single communication channel between the sender 120 and the receiver is determined. By way of example, in some embodiments the adaptive streaming module 115 may track the available bandwidth on the communication channel between the sender 120 and receiver 140. Control then passes to operation 335 and the adaptive streaming module 115 selects a stream from the plurality of parallel content streams to transmit via the communication channel. In some embodiments the adaptive streaming module 115 may implement a best-available quality procedure which selects the highest bandwidth content stream that fits within the available bandwidth on the communication channel. In other embodiments the adaptive streaming module may simply select any content stream which fits the available bandwidth on the communication channel.

Referring back to operation 325, if there are multiple channels available then control passes to operation 340 and the available bandwidth in all the available communication channels between the sender 120 and the receiver is determined. By way of example, in some embodiments the adaptive streaming module 115 may track the available bandwidth on the communication channels between the sender 120 and receiver 140. Control then passes to operation 345 and the adaptive streaming module 115 fits multiple content streams from the plurality of parallel content streams to transmit via the communication channels. Again, in some embodiments the adaptive streaming module 115 may implement a best-available quality procedure which selects the highest bandwidth content stream that fits within the available bandwidth of the given communication channel. In other embodiments the adaptive streaming module may simply select any content stream which fits the available bandwidth on the communication channel.

At operation 350 the content stream(s) assigned for transmission from the sender 120 to the receiver 140 are transmitted from the sender 120. At operation 355 the receiver 140 receives the content stream(s). In some embodiments the adaptive streaming module 145 on the receiver 140 include logic to manage buffering the content stream(s) in memory. At operation 360 the content stream(s) are buffered and, if there are multiple streams then the content streams are combined into a combined content stream.

At operation 365 the combined content stream may be decoded, e.g., by a conventional video decoder, and at operation 370 the decoded combined content stream may be presented on a user interface, e.g., a display coupled to the receiver.

In the foregoing discussion, specific implementations of exemplary processes have been described, however, it should be understood that in alternate implementations, certain acts need not be performed in the order described above. In alternate embodiments, some acts may be modified, performed in a different order, or may be omitted entirely, depending on the circumstances. Moreover, in various alternate implementations, the acts described may be implemented by a computer, controller, processor, programmable device, firmware, or any other suitable device, and may be based on instructions stored on one or more computer-readable media or otherwise stored or programmed into such devices (e.g. including transmitting computer-readable instructions in real time to such devices). In the context of software, the acts described above may represent computer instructions that, when executed by one or more processors, perform the recited operations. In the event that computer-readable media are used, the computer-readable media can be any available media that can be accessed by a device to implement the instructions stored thereon.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A computer-based method to manage content streaming from a sender to a receiver, comprising:
splitting an encoded content stream into a plurality of parallel content streams including:
a first content stream comprising a base layer and at least a first additional layer, wherein the base layer contains a low-bandwidth content stream and reference information for additional layers; and
a second content stream comprising the base layer and at least a second additional layer; and
transmitting at least one of the first content stream or the second content stream from the sender to the receiver based at least in part on an available bandwidth parameter.

2. The method of claim 1, further comprising:
determining whether multiple communication channels are available between the sender and the receiver, and in response to a determination that only a single communication channel is available:
determining an available bandwidth on the single communication channel between the sender and the receiver; and
selecting a content stream from the plurality of parallel content streams based at least in part on the bandwidth required by the content stream.

3. The method of claim 2, further comprising:
receiving the content stream in the receiver;
decoding the content stream; and
presenting the content stream on a display.

4. The method of claim 1, further comprising:
determining whether multiple communication channels are available between the sender and the receiver, and in response to a determination that multiple communication channels are available:
determining an available bandwidth on the multiple communication channels between the sender and the receiver; and
selecting a content stream from the plurality of parallel content streams for the respective multiple communication channels based at least in part on the bandwidth required by the content stream.

5. The method of claim 4, further comprising:
transmitting the plurality of parallel content streams across the multiple communication channels.

6. The method of claim 5, further comprising:
receiving the plurality of parallel content streams in the receiver;
buffering the plurality of parallel content streams in a buffer; and
combining the plurality of parallel content streams to create a combined content stream in the receiver.

7. The method of claim 6, further comprising:
decoding the combined content stream; and
presenting the decoded combined content stream on a display.

8. A computer-based system to manage content streaming from a sender to a receiver, comprising:
a processor; and
logic instructions stored in a tangible computer-readable medium coupled to the processor which, when executed by the processor, configure the processor to:
split an encoded content stream into a plurality of parallel content streams including:
a first content stream comprising a base layer and at least a first additional layer, wherein the base layer contains a low-bandwidth content stream and reference information for additional layers; and
a second content stream comprising the base layer and at least a second additional layer; and
a transmitter to transmit at least one of the first content stream or the second content stream from the sender to the receiver based at least in part on an available bandwidth parameter.

9. The computer-based system of claim 8, further comprising logic instructions stored in a tangible computer-readable medium coupled to the processor which, when executed by the processor, configure the processor to:
determine whether multiple communication channels are available between the sender and the receiver, and in response to a determination that only a single communication channel is available:
determine an available bandwidth on the single communication channel between the sender and the receiver; and
select a content stream from the plurality of parallel content streams based at least in part on the bandwidth required by the content stream.

10. The computer-based system of claim 9, further comprising:
a receiver to receive the content stream;
a processor coupled to the receiver; and
logic instructions stored in a tangible computer-readable medium coupled to the processor which, when executed by the processor, configure the processor to:
decode the content stream; and
present the content stream on a display.

11. The computer-based system of claim 8, further comprising logic instructions stored in a tangible computer-readable medium coupled to the processor which, when executed by the processor, configure the processor to:
determine whether multiple communication channels are available between the sender and the receiver, and in response to a determination that multiple communication channels are available:
determine an available bandwidth on the multiple communication channels between the sender and the receiver; and
select a content stream from the plurality of parallel content streams for the respective multiple communication channels based at least in part on the bandwidth required by the content stream.

12. The computer-based system of claim 11, further comprising:
a transmitter to transmit the plurality of parallel content streams across the multiple communication channels.

13. The computer-based system of claim 12, further comprising:
a receiver to receive the plurality of parallel content streams; and
a processor coupled to the receiver; and
logic instructions stored in a tangible computer-readable medium coupled to the processor which, when executed by the processor, configure the processor to:
buffer the plurality of parallel content streams in a buffer; and
combine the plurality of parallel content streams to create a combined content stream in the receiver.

14. The computer-based system of claim 13, further comprising logic instructions stored in a tangible computer-readable medium coupled to the processor which, when executed by the processor, configure the processor to:
decode the combined content stream; and
present the decoded combined content stream on a display.

15. A computer program product comprising logic instructions stored in a tangible computer-readable medium coupled to a processor which, when executed by the processor, configure the processor to:
split an encoded content stream into a plurality of parallel content streams including:
a first content stream comprising a base layer and at least a first additional layer, wherein the base layer contains a low-bandwidth content stream and reference information for additional layers; and
a second content stream comprising the base layer and at least a second additional layer; and
forward the first content stream and second content stream to a transmitter to transmit at least one of the first content stream or the second content stream from a sender to a receiver based at least in part on an available bandwidth parameter.

16. The computer program product of claim 15, further comprising logic instructions stored in a tangible computer-readable medium coupled to the processor which, when executed by the processor, configure the processor to:
determine whether multiple communication channels are available between the sender and the receiver, and in response to a determination that only a single communication channel is available:
determine an available bandwidth on the single communication channel between the sender and the receiver; and
select a content stream from the plurality of parallel content streams based at least in part on the bandwidth required by the content stream

17. The computer program product of claim 16, further comprising logic instructions stored in a tangible computer-readable medium coupled to a processor in a receiver which receives the content stream which, when executed by the processor, configure the processor to:
decode the content stream; and
present the content stream on a display.

18. The computer program product of claim 15, further comprising logic instructions stored in a tangible computer-readable medium coupled to the processor which, when executed by the processor, configure the processor to:
determine whether multiple communication channels are available between the sender and the receiver, and in response to a determination that multiple communication channels are available:
determine an available bandwidth on the multiple communication channels between the sender and the receiver; and
select a content stream from the plurality of parallel content streams for the respective multiple communication channels based at least in part on the bandwidth required by the content stream.

19. The computer program product of claim 18, further comprising logic instructions stored in a tangible computer-readable medium coupled to a processor in a receiver which receives the content stream which, when executed by the processor, configure the processor to:
buffer the plurality of parallel content streams in a buffer; and
combine the plurality of parallel content streams to create a combined content stream in the receiver.

20. The computer program product of claim 18, further comprising logic instructions stored in a tangible computer-readable medium coupled to a processor in a receiver which receives the content stream which, when executed by the processor, configure the processor to:
decode the combined content stream; and
present the decoded combined content stream on a display.
